(19) United States
(12) Patent Application Publication
(10) Pub. No.: US 2009/0091277 A1
(43) Pub. Date: Apr. 9, 2009

(54) Dust extractor for a battery-operated electric hand-held power tool

(75) Inventor: Rainer Ontl, Landsberg am Lech (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 12/287,227

(22) Filed: Oct. 6, 2008

(30) Foreign Application Priority Data
Oct. 8, 2007 (DE) 10 2007 000 826.2

(51) Int. Cl. H02P 4/00

(52) U.S. Cl. 318/139

(57) ABSTRACT

A dust extraction module (4) for a battery-operated electric hand-held power tool (2a, 2b) includes a fan wheel (5), a DC motor (6) for driving the fan wheel (5), and a DC chopper converter (7) arranged upstream of the DC motor (6) and connectable with a battery module (3a, 3b) of the power tool (2a, 2b) for converting a battery voltage (UAa, UAb) of the battery module (3a, 3b) to a motor voltage (UM) of the DC motor (6).

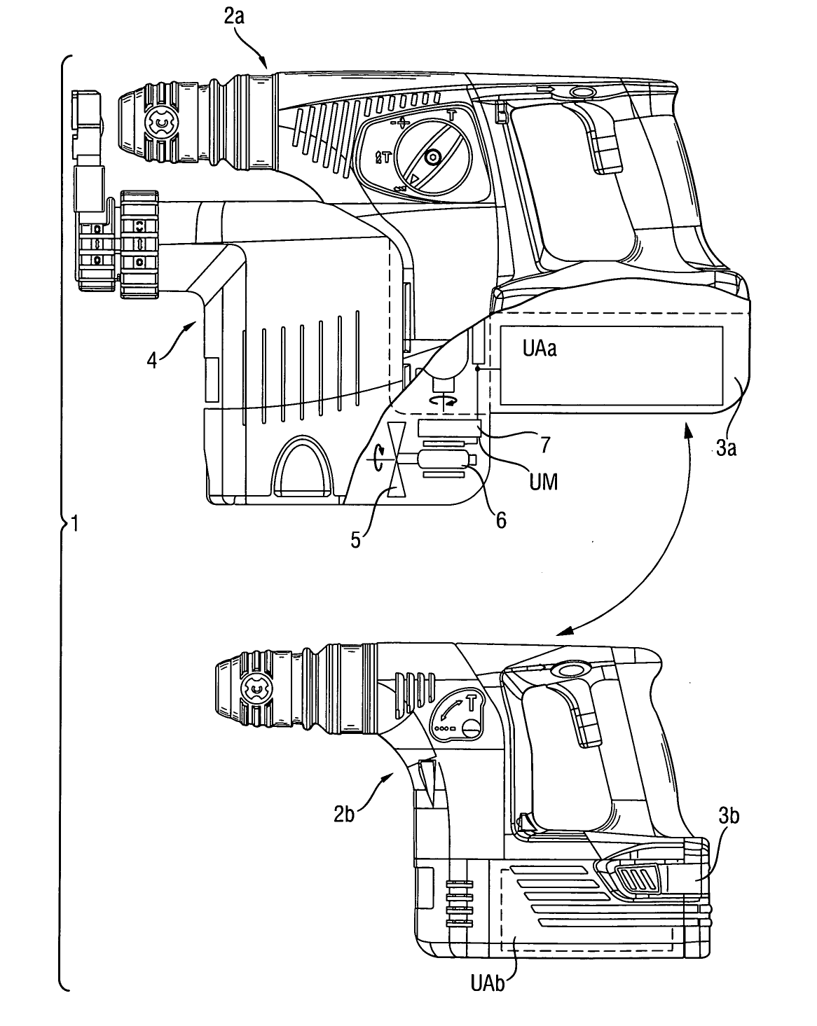

### BACKGROUND OF THE INVENTION

1. Field of the Invention

The invention is directed to a dust extraction module with an electric motor which can be fitted to a battery-operated electric hand-held power tool and is energized by the power tool, particularly, to a hammer drill or chisel hammer.

2. Description of the Prior Art

Battery-operated electric hand-held power tools are usually manufactured modularly in different power classes to meet the requirements and preferences of customers with respect to power capacity and weight in an optimal manner. Further, the development of battery cell technology requires novel types of cells resulting in different module voltages of the battery-operated electric hand-held power tool and of the associated battery module.

The dust occurring during drilling and chiseling work is unhealthy for the user and increases the workload as well as the wear and tear on electric hand-held power tools. Dust extraction modules suitable for extracting dust at the point of origin have a suction head at the point of origin which is connected to a suction tube of variable length in which a fan wheel provides for the vacuum. The extracted dust is filtered out in a dust filter and captured in a dust container.

Dust extraction modules of the type described above and the fan wheel of which that serves to aspirate the dust, is energized mechanically by the electric hand-held power tool, are known, for example, from U.S. Pat. No. 6,851,898.

According to U.S. Pat. No. 7,182,150, a DC motor is arranged in a dust extraction module for a battery-operated electric hand-held power tool with a battery module for driving the fan wheel. Module electronics, which controls the DC motor depending on the control switch of the battery-operated electric hand-held power tool, is connected upstream of the DC motor.

### SUMMARY OF THE INVENTION

It is the object of the invention to provide a dust extraction module which is suitable for battery-operated electric hand-held power tools with different module voltage.

This and other objects of the present invention, which will become apparent hereinafter, are achieved by providing a dust extraction module for a battery-operated electric hand-held power tool having a battery module and which has a fan wheel connected to a DC motor that is powered by the battery module of the power tool. A DC chopper converter is arranged upstream of the DC motor for converting a battery voltage of the battery module to a motor voltage of the DC motor.

By connecting a DC chopper converter (DC-to-DC converter) upstream of the DC motor, the DC motor can be designed for a motor voltage different than the battery voltage of the battery module. In particular a lower motor voltage, which corresponds to the lowest battery voltage in the modular system of different battery-operated electric hand-held power tools with associated battery modules, can be obtained. The conversion of the battery voltage to the lower motor voltage is carried out by the DC chopper converter in the form of a step-down converter which is only available in the dust extraction modules that are manufactured in relatively small unit numbers (compared to the quantity of battery-operated electric hand-held power tools).

The DC chopper converter is advantageously an inductive converter so that the conversion is also carried out at higher currents without losses.

A battery-operated hand-held tool system advantageously includes at least two battery-operated electric hand-held power tools, each with associated battery modules of different battery voltage, and the dust extraction module with the DC motor. Its motor voltage corresponds to the lower battery voltage so that the DC motor can be operated at maximum system power. The novel features of the present invention which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

Single FIGURE of the drawings shows a schematic side view of the battery-operated hand-held tool system.

### DETAILED DESCRIPTION OF THE PREFERRED EMBODIMENT

As is shown in the drawing, a battery-operated hand-held tool system 1 includes two battery-operated electric hand-held power tools 2a, 2b, each having an associated battery module 3a, 3b of different battery voltages UAa, UAb, and a dust extraction module 4 (which can be combined with both depending upon the task) with a fan wheel 5 connected to a DC motor 6. Upstream of the DC motor 6 which is powered by the battery module 3a with battery voltage UAa and the motor voltage UM of which corresponds to the lower battery voltage MIN(UAa, UAb), there is provided a DC chopper converter 7 in the form of an inductive step-down converter which reduces the battery voltage UAa to the motor voltage UM.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A dust extraction module for a battery-operated electric hand-held power tool (2a, 2b) having a battery module (3a, 3b), comprising a fan wheel (5); a DC motor (6) for driving the fan wheel (5); and a DC chopper converter (7) arranged upstream of the DC motor (6) and connectable with the battery module (3a, 3b) for converting a battery voltage (UAa, UAb) of the battery module (3a, 3b) to a motor voltage (UM) of the DC motor (6).

2. A dust extraction module according to claim 1, wherein the DC chopper converter (7) is an inductive converter.

3. A dust extraction module according to claim 1, wherein the dust extraction module is associated with at least two battery-operated electric hand-held power tools (2a, 2b) having, respectively, battery modules (3a, 3b) of different battery voltage (UAa, UAb), and wherein the motor voltage (UM) of the DC motor (6) corresponds to a lower battery voltage (MIN(UAa, UAb)).
